(19) United States
(12) Patent Application Publication
(10) Pub. No.: US 2003/0080048 A1
(43) Pub. Date: May 1, 2003

(54) Opening/closing structure for a tea-leaf filtering box of a tea-brewing device

(76) Inventor: Yen Huei Lin, Taipei City (TW)

Correspondence Address: LIN Yen Huei, P.O. Box 82-144, Taipei, TW

(21) Appl. No.: 09/986,520

(22) Filed: Nov. 1, 2001

(51) Int. Cl. B01D 35/02

(52) U.S. Cl. 210/464; 210/470

(57) ABSTRACT

An opening/closing structure for a tea-leaf filtering box of tea-brewing device is disclosed. The opening/closing a filtering box includes a body and a lid provided with a plurality of pores, the body including a frame body at the edge thereof, a bottom edge frame body and a plurality of supporting wire, characterized in that a bottom board is provided to the bottom frame body, and the center of the board and the center of the lid are respectively provided with a female threaded rod and a screw rod corresponding to each other, the screw rod passes through the top surface end of the lid and is pivotally connected to a lifting rod, thereby the rotating of the lifting will cause the screw rod to connect with the female threaded rod or to unscrew to dislocate with the lid so as to either lifting up the container or to lower the container to brew tea. The repeating process of lifting up and lowering down the tea leaf-filtering box can expedite the brewing of tea.

### BACKGROUND OF THE INVENTION

(a) Technical Field of the Invention

The present invention relates to an improved structure of an opening/closing member for a tea-leaf filtering box, and in particular, an opening/closing structure, which facilitates tea brewing, and opening of the filtering box without hurting or burning the hands of the user.

(b) Description of the Prior Art

If tea leaves are kept or immersed too long in hot water or in brewed tea, the taste of the brewed tea will change. FIG. 1 shows a shell-type filtering box 10 comprising two substantially hemisphere bodies closed to each other with an actuation body 11. However, the drawback of tea leaves immersed in the brewed tea has not been improved.

FIGS. 2 and 3 show a conventional tea-brewing device having a tea leaves filtering box 20, which can be lifted or pushed down by means of a rod. The filtering box 20 comprises a box body 21 and a cover 22 with a plurality of air holes. The box body 21 comprises an opening edge frame body 211, bottom edge frame body 212 and a plurality of supporting wires 213. The box body 21 is tightened by the frame body 211 and the edge 221 of the box. The protrusion 214 and a notch 222 are corresponding to each other for mounting. The cover 22 is attached to a securing rod 23 at one end and the securing rod 23 is pivotally connected to a pushing and lifting rod 24. The rod 24 passes through the top cover 31 of the tea-brewing device 30. The pushing and lifting rod 24 pushes down or lifts up the box 20. After tea has been brewed, the box 20 is lifted up and the rod 24 is bent so as to separate the box 20 from contacting the brewed tea, avoiding the immersion of tea leaves within the brewed tea. However, the drawback of this conventional tea-brewing device is that the box may not be easily separated from the cover 22.

One hand is used to hold the box body 21 and the other hand is used to force the cover 22 to open. As a greater force is required to open the cover 22, the hand may be accidentally hurt and cut by the edge of the box 20. Furthermore, the metallic material immersed in a hot brewed tea may burn the hand. In additional, the cover 22 may not be tightened properly with the box body 21, and this will cause the body containing tea leaves to leave in the hot brewed tea when the rod 24 is lifted up. Therefore, it is an object of the present invention to provide an opening/closing structure for a tea-leaf filtering box of a tea-brewing device so as to mitigate the above-mentioned drawbacks.

### SUMMARY OF THE INVENTION

Accordingly, it is an object of the present invention to provide an opening/closing structure for a tea-leaf filtering box of a tea-brewing device comprising a filtering container including a body and a lid provided with a plurality of pores, the body including a frame body at the edge thereof, a bottom edge frame body and a plurality of supporting wire, characterized in that a bottom board is provided to the bottom frame body, and the center of the board and the center of the lid are respectively provided with a female threaded rod and a screw rod corresponding to each other, the screw rod passes through the top surface end of the lid and is pivotally connected to a lifting rod, thereby the rotating of the lifting will cause the screw rod to connect with the female threaded rod or to unscrew to dislocate with the lid so as to either lifting up the container or to lower the container to brew tea.

Yet another object of the present invention is to provide an opening/closing structure for a tea-leaf filtering box of a tea-brewing device, wherein the body of the tea-leaf filtering box will not drop into the tea-brewing device, thereby the box can be repeatedly lifted up and lowered down to expedite tea brewing process.

A further object of the present invention is to provide an opening/closing structure for a tea-leaf filtering box of a tea-brewing device, wherein the opening of the tea-leaf filtering box is simple by unscrewing the screw rod connected to the lifting rod of the tea-brewing device.

The foregoing object and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a perspective view of a conventional tea-leaf filtering container.

FIG. 2 is a perspective exploded view of a conventional lifting-type tea-leaf container.

FIG. 3 is a perspective view of a conventional lifting-type tea-leaf container.

FIG. 4 is a perspective view of the opening/closing structure for a tea-leaf filtering box of a tea-brewing device of the present invention.

FIG. 5 is a perspective view of the opening/closing structure for a tea-leaf filtering box of a tea-brewing device of the present invention.

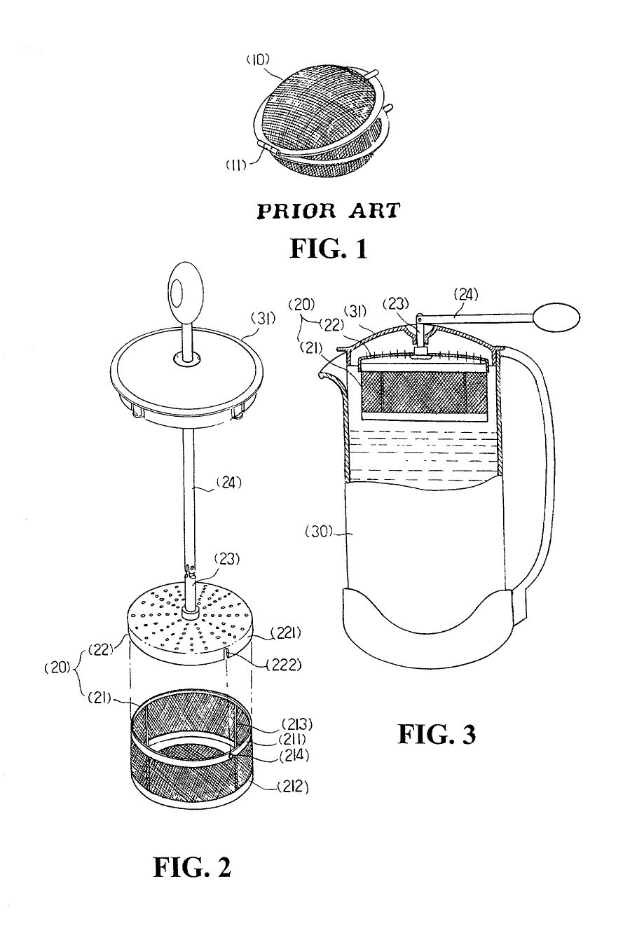

### DETAILED DESCRIPTION OF THE PREFERRED EMBODIMENT

For the purpose of promoting an understanding of the principles of the invention, reference will now be made to the embodiment illustrated in the drawings. Specific language will be used to describe same. It will, nevertheless, be understood that no limitation of the scope of the invention is thereby intended, alterations and further modifications in the illustrated device, and further applications of the principles of the invention as illustrated herein being contemplated as would normally occur to one skilled in the art to which the invention relates.

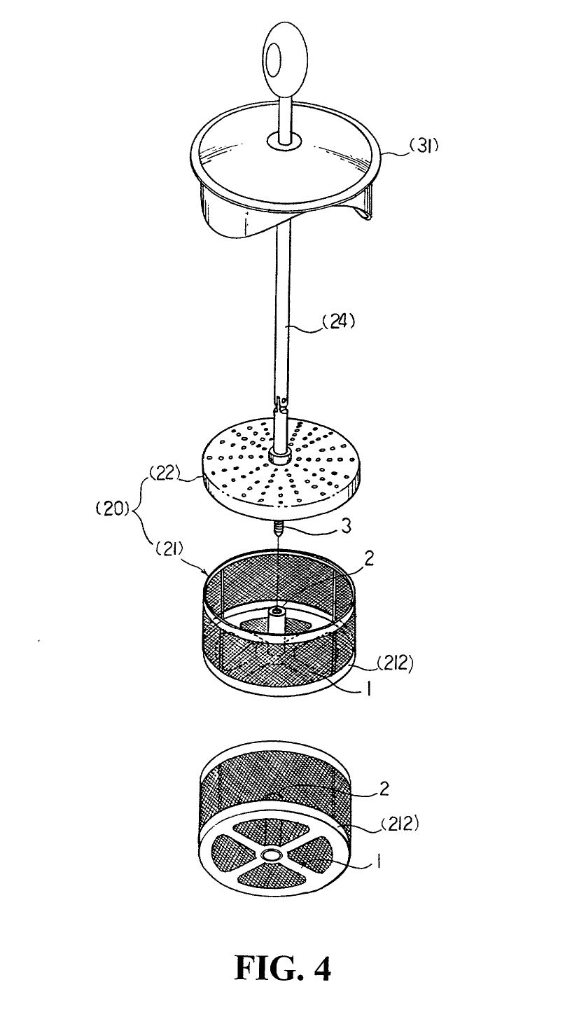

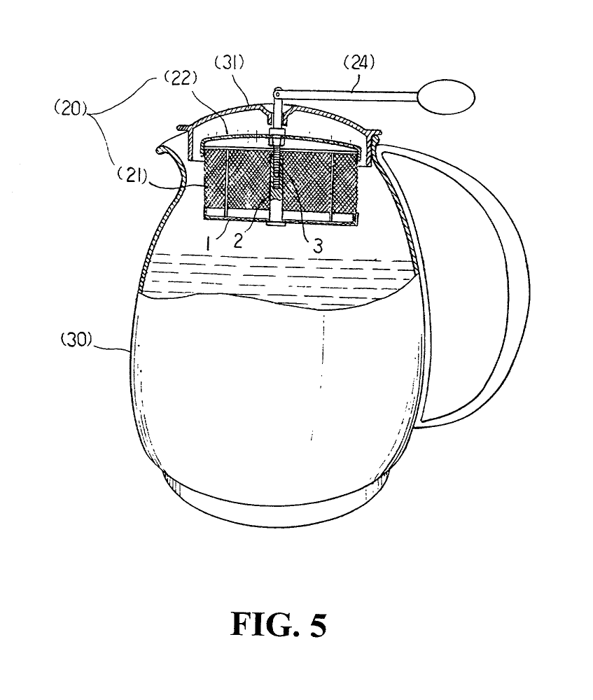

Referring to FIGS. 4 and 5, there is shown an opening/closing structure for a tea-leaf filtering box of a tea-brewing device, wherein the tea-leaf filtering box 30 includes a box body 21 and a lid 22. The bottom edge frame body 212 of the box body 21 is mounted with a bottom frame board 1. The center of the frame board 1 and the center of the lid 22 are respectively mounted with a female threaded rod 2 and a screw rod 3. The portion that is protruded beyond the top surface end of the lid does not have a threaded section, and the end section thereof is pivotally connected to a pushing/lifting rod 24. The pushing/lifting rod 24 passes through the top cover 31 of the tea-brewing device 30. The rotating of the rod 24 causes the female threaded rod 2 to join with or to dislocate from the screw rod 3 so that the lid 22 is connected with/separated from the body 21. The elevating or lowering of the filtering box is achieved by pushing/lifting of the rod 24. After the filtering box 20 has reached the bottom face of the top cover 31, the box 20 will be separated from the brewed tea so as to preserve the taste of tea.

In accordance with the present invention, the separation of the female threaded rod 2 with the screw rod 3 by rotating the rod 24 so as to separate the lid 22 will not hurt or bum the user's hands, and in addition, the box body 21 will not drop into the brewing device 30.

The user can lift up and lower down the box body 21 and the tea brewing process is faster as compared to the conventional tea-brewing device.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. An opening/closing structure for a tea-leaf filtering container lid of a tea-brewing device having a filtering box including a body and a lid provided with a plurality of pores, the body including a frame body at the edge thereof, a bottom edge frame body and a plurality of supporting wires, characterized in that a bottom board is provided to the bottom edge frame body, and the center of the board and the center of the lid are respectively provided with a female threaded rod and a screw rod corresponding to each other, the screw rod passes through the top surface end of the lid and is pivotally connected to a lifting rod, thereby the rotating of the lifting rod will cause the screw rod to connect with the female threaded rod or to unscrew to dislocate with the lid so as to either lifting up the box or to lower the box to brew tea.
